(19) United States
(12) Patent Application Publication
(10) Pub. No.: US 2022/0326576 A1
(43) Pub. Date: Oct. 13, 2022

(54) ALIGNMENT FILM MATERIAL AND LIQUID CRYSTAL DISPLAY DEVICE

(71) Applicant: Japan Display Inc., Tokyo (JP)

(72) Inventors: Yasushi Tomioka, Tokyo (JP); Kentaro Okuyama, Tokyo (JP)

(21) Appl. No.: 17/706,916

(22) Filed: Mar. 29, 2022

(30) Foreign Application Priority Data
Mar. 30, 2021 (JP) 2021-057983

(51) Int. Cl. G02F 1/1337; G02F 1/1334; G02F 1/137

(52) U.S. Cl. CPC G02F 1/133723; G02F 1/13345; G02F 1/133784; G02F 1/137; G02F 1/133788; G02F 2203/03; G02F 1/1368

(57) ABSTRACT

According to an aspect, a liquid crystal display device includes: a first light-transmitting substrate; a second light-transmitting substrate disposed so as to be opposed to the first light-transmitting substrate; a liquid crystal layer sealed between the first light-transmitting substrate and the second light-transmitting substrate; alignment films that are provided to the first light-transmitting substrate and the second light-transmitting substrate, respectively, and are in contact with the liquid crystal layer; and at least one light emitter disposed so as to be opposed to at least one of side surfaces of the first light-transmitting substrate and the second light-transmitting substrate. The liquid crystal layer includes a polymer-dispersed liquid crystal comprising a polymer network formed in a mesh shape and liquid crystal molecules held in a dispersed manner in gaps of the polymer network, and each of the alignment films comprises a photocrosslinkable group connected to the polymer network.

### CROSS-REFERENCE TO RELATED APPLICATION

This application claims the benefit of priority from Japanese Patent Application No. 2021-057983 filed on Mar. 30, 2021, the entire contents of which are incorporated herein by reference.

### BACKGROUND

### 1. Technical Field

What is disclosed herein relates to an alignment film material and a liquid crystal display device.

### 2. Description of the Related Art

Japanese Patent Application Laid-open Publication No. 2018-021974 describes a display device that includes a first light-transmitting substrate, a second light-transmitting substrate disposed so as to be opposed to the first light-transmitting substrate, a liquid crystal layer sealed between the first light-transmitting substrate and the second light-transmitting substrate, and at least one light emitter disposed so as to be opposed to at least one of side surfaces of the first light-transmitting substrate and the second light-transmitting substrate. An alignment film (liquid crystal alignment film) is provided on at least one of inner surfaces of the first light-transmitting substrate and the second light-transmitting substrate of a display panel formed with the first light-transmitting substrate, the second light-transmitting substrate, and the liquid crystal layer.

In this type of display device, the liquid crystal layer contains liquid crystal molecules held in a dispersed manner in gaps of a polymer network formed in a mesh shape. For example, when no current flows, the alignment film orients the liquid crystal molecules to bring the liquid crystal molecules of the liquid crystal layer into a non-scattering state of not scattering light of the light emitter. As a result, the display device allows a viewer on one surface side of the display panel to view a background on the other surface side opposite to the one surface side.

In conventional display devices, for example, repetition of point presses or drop impact on a screen of the display panel irreversibly moves the polymer network of the liquid crystal layer, thereby disturbing the orientation of the liquid crystal molecules. This phenomenon causes unevenness and reduced contrast in the vicinity of the center of the screen of the display panel, and thus, improvement is required in impact resistance of the display devices.

For the foregoing reasons, there is a need for an alignment film material and a liquid crystal display device capable of improving the impact resistance.

### SUMMARY

According to an aspect, an alignment film material that is used for a polymer-dispersed liquid crystal includes a photocrosslinkable group to be connected to a photocrosslinkable monomer comprised in the polymer-dispersed liquid crystal.

According to an aspect, a liquid crystal display device includes: a first light-transmitting substrate; a second light-transmitting substrate disposed so as to be opposed to the first light-transmitting substrate; a liquid crystal layer sealed between the first light-transmitting substrate and the second light-transmitting substrate; alignment films that are provided to the first light-transmitting substrate and the second light-transmitting substrate, respectively, and are in contact with the liquid crystal layer; and at least one light emitter disposed so as to be opposed to at least one of side surfaces of the first light-transmitting substrate and the second light-transmitting substrate. The liquid crystal layer includes a polymer-dispersed liquid crystal comprising a polymer network formed in a mesh shape and liquid crystal molecules held in a dispersed manner in gaps of the polymer network, and each of the alignment films comprises a photocrosslinkable group connected to the polymer network.

### BRIEF DESCRIPTION OF THE DRAWINGS

FIG. 1 is a perspective view illustrating an example of a display device according to an embodiment of the present disclosure;

FIG. 2 is a block diagram illustrating the display device of a first embodiment of the present disclosure;

FIG. 3 is a timing diagram explaining timing of light emission by a light source in a field-sequential system of the first embodiment;

FIG. 4 is an explanatory diagram illustrating a relation between a voltage applied to a pixel electrode and a scattering state of a pixel;

FIG. 5 is a sectional view illustrating an example of a section of the display device of FIG. 1;

FIG. 6 is a plan view illustrating a planar surface of the display device of FIG. 1;

FIG. 7 is an enlarged sectional view obtained by enlarging a liquid crystal layer portion of FIG. 5;

FIG. 8 is a sectional view illustrating a state of a monomer before being polymerized in the liquid crystal layer;

FIG. 9 is a sectional view for explaining the scattering state in the liquid crystal layer;

FIG. 10 is a sectional view illustrating a state of the monomer before being polymerized in the liquid crystal layer according to a second embodiment of the present disclosure;

FIG. 11 is a sectional view for explaining a non-scattering state in the liquid crystal layer; and

FIG. 12 is a sectional view for explaining the scattering state in the liquid crystal layer.

### DETAILED DESCRIPTION

The following describes modes (embodiments) for carrying out the present disclosure in detail with reference to the drawings. The present disclosure is not limited to the description of the embodiments given below. Components described below include those easily conceivable by those skilled in the art or those substantially identical thereto. Moreover, the components described below can be appropriately combined. What is disclosed herein is merely an example, and the present disclosure naturally encompasses appropriate modifications easily conceivable by those skilled in the art while retaining the gist of the disclosure. To further clarify the description, the drawings schematically illustrate, for example, widths, thicknesses, shapes, and the like of various parts as compared with actual aspects thereof, in some cases. However, they are merely examples, and interpretation of the present disclosure is not limited thereto. The same element as that illustrated in a drawing that has already been discussed is denoted by the same reference numeral through the description and the drawings, and detailed description thereof will not be repeated in some cases where appropriate.

### First Embodiment

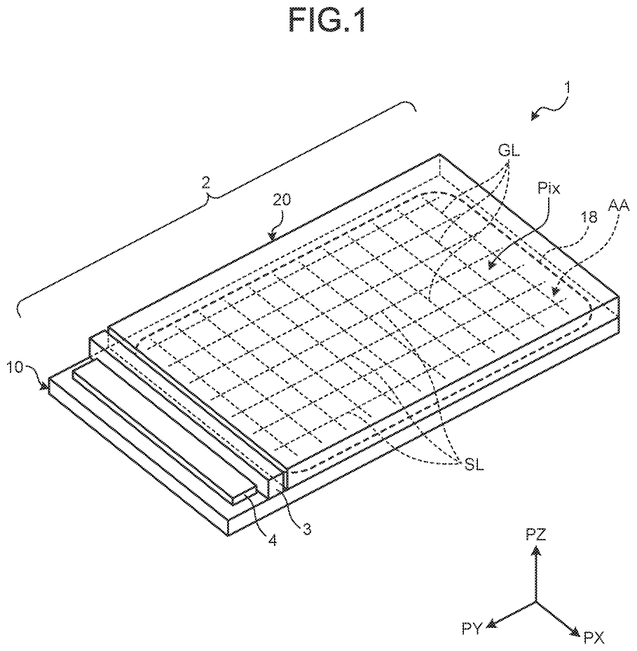

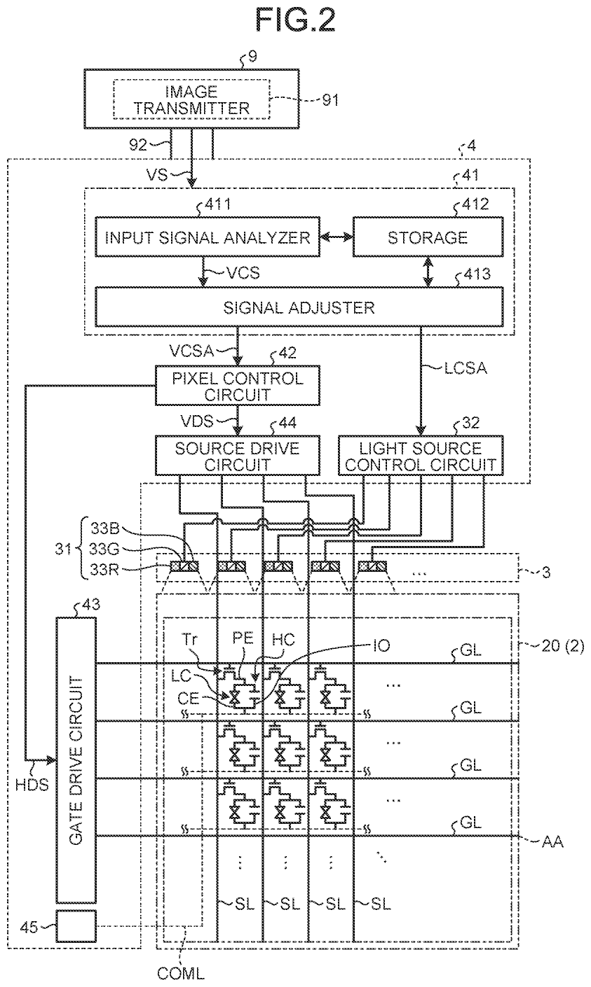

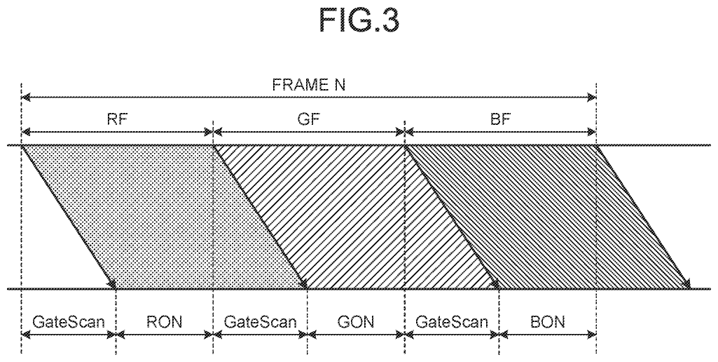

FIG. 1 is a perspective view illustrating an example of a display device according to a first embodiment of the present disclosure. FIG. 2 is a block diagram illustrating the display device of FIG. 1. FIG. 3 is a timing diagram explaining timing of light emission by a light source in a field-sequential system.

As illustrated in FIG. 1, a display device (liquid crystal display device) 1 includes a display panel 2, a light source 3, and a drive circuit 4. A PX direction denotes one direction on a planar surface of the display panel 2. A PY direction denotes a direction orthogonal to the PX direction. A PZ direction denotes a direction orthogonal to a PX-PY plane.

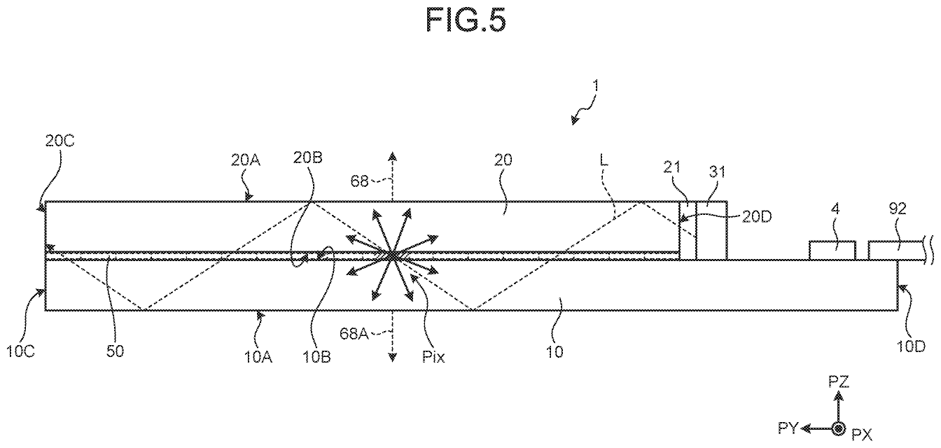

The display panel 2 includes an array substrate (first light-transmitting substrate) 10, a counter substrate (second light-transmitting substrate) 20, and a liquid crystal layer 50 (refer to FIG. 5). The counter substrate 20 is opposed to a surface of the array substrate 10 in a direction orthogonal thereto (in the PZ direction as indicated in FIG. 1). The liquid crystal layer 50 is disposed between the array substrate 10 and the counter substrate 20. The liquid crystal layer 50 contains polymer-dispersed liquid crystal (PDLC) LC to be described later. The polymer-dispersed liquid crystal LC is sealed by the array substrate 10, the counter substrate 20, and a sealing portion 18.

As illustrated in FIG. 1, the inside of the sealing portion 18 in the display panel 2 serves as a display area AA capable of displaying an image. A plurality of pixels Pix are arranged in a matrix having a row-column configuration in the display area AA. In the present disclosure, a row refers to a pixel row including m pixels Pix arranged in one direction. In addition, a column refers to a pixel column including n pixels Pix arranged in a direction orthogonal to the direction in which the rows extend. The values of m and n are defined depending on a display resolution in the vertical direction and a display resolution in the horizontal direction. A plurality of scanning lines GL are provided corresponding to the rows, and a plurality of signal lines SL are provided corresponding to the columns.

The light source 3 includes a plurality of light emitters 31 optically coupled to the display panel 2. A gap between the display panel 2 and the light emitters 31 is filled with an optical adhesive layer 21 (refer to FIG. 5). As illustrated in FIG. 2, a light source control circuit 32 is included in the drive circuit 4. The light source control circuit 32 may be a circuit separate from the drive circuit 4. The light emitters 31 are electrically coupled to the light source control circuit 32 through wiring in the array substrate 10.

As illustrated in FIG. 1, the drive circuit 4 is provided on the surface of the array substrate 10. As illustrated in FIG. 2, the drive circuit 4 includes a signal processing circuit 41, a pixel control circuit 42, a gate drive circuit 43, a source drive circuit 44, and a common potential drive circuit 45. The array substrate 10 has an area in the PX-PY plane larger than that of the counter substrate 20, and the drive circuit 4 is provided on a projecting portion of the array substrate 10 exposed from the counter substrate 20.

The signal processing circuit 41 receives a first input signal (such as a red-green-blue (RGB) signal) VS from an image transmitter 91 of an external controller 9 through a flexible substrate 92.

The signal processing circuit 41 includes an input signal analyzer 411, a storage 412, and a signal adjuster 413. The input signal analyzer 411 generates a second input signal VCS based on an externally received first input signal VS.

The second input signal VCS is a signal for determining a gradation value to be given to each of the pixels Pix of the display panel 2 based on the first input signal VS. In other words, the second input signal VCS is a signal including gradation information on the gradation value of each of the pixels Pix.

The signal adjuster 413 generates a third input signal VCSA from the second input signal VCS. The signal adjuster 413 transmits the third input signal VCSA to the pixel control circuit 42, and transmits a light source control signal LCSA to the light source control circuit 32. The light source control signal LCSA is a signal including information on light quantities of the light emitters 31 set in accordance with, for example, input gradation values given to the pixels Pix. For example, the light quantities of the light emitters 31 are set smaller when a darker image is displayed. When a brighter image is displayed, the light quantities of the light emitters 31 are set larger.

The pixel control circuit 42 generates a horizontal drive signal HDS and a vertical drive signal VDS based on the third input signal VCSA. In the present embodiment, since the display device 1 is driven by the field-sequential system, the horizontal drive signal HDS and the vertical drive signal VDS are generated for each color emittable by the light emitter 31.

The gate drive circuit 43 sequentially selects the scanning lines GL of the display panel 2 based on the horizontal drive signal HDS during one vertical scanning period. The scanning lines GL can be selected in any order.

The source drive circuit 44 supplies a gradation signal corresponding to the output gradation value of each of the pixels Pix to a corresponding one of the signal lines SL of the display panel 2 based on the vertical drive signal VDS during one horizontal scanning period.

In the present embodiment, the display panel 2 is an active matrix panel. Hence, the display panel 2 includes the signal (source) lines SL extending in the PY direction and the scanning (gate) lines GL extending in the PX direction in a plan view, and includes switching elements Tr at intersecting portions between the signal lines SL and the scanning lines GL.

A thin-film transistor is used as each of the switching elements Tr. A bottom-gate transistor or a top-gate transistor may be used as an example of the thin-film transistor. Although a single-gate thin film transistor is exemplified as the switching element Tr, the switching element Tr may be a double-gate transistor. One of the source electrode and the drain electrode of the switching element Tr is coupled to a corresponding one of the signal lines SL. The gate electrode of the switching element Tr is coupled to a corresponding one of the scanning lines GL. The other of the source electrode and the drain electrode is coupled to one end of a capacitance of the polymer-dispersed liquid crystal LC to be described later. The capacitance of the polymer-dispersed liquid crystal LC is coupled at one end thereof to the switching element Tr through a pixel electrode PE, and coupled at the other end thereof to common potential wiring COML through a common electrode CE. A holding capacitance HC is generated between the pixel electrode PE and a holding capacitance electrode IO electrically coupled to the common potential wiring COML. A potential of the common potential wiring COML is supplied by the common potential drive circuit 45.

Each of the light emitters 31 includes a light emitting body 33R of a first color (such as red), a light emitting body 33G of a second color (such as green), and a light emitting body 33B of a third color (such as blue). The light source control circuit 32 controls the light emitting body 33R of the first color, the light emitting body 33G of the second color, and the light emitting body 33B of the third color so as to emit light in a time-division manner based on the light source control signal LCSA. In this manner, the light emitting body 33R of the first color, the light emitting body 33G of the second color, and the light emitting body 33B of the third color are driven based on the field-sequential system.

As illustrated in FIG. 3, in a first sub-frame (first predetermined time) RF, the light emitting body 33R of the first color emits light during a first color light emission period RON, and the pixels Pix selected during one vertical scanning period GateScan scatter light to perform display. On the entire display panel 2, for the pixels Pix selected during the one vertical scanning period GateScan, if the gradation signal corresponding to the output gradation value of each of the pixels Pix is supplied to the above-described signal lines SL, only the first color is lit up during the first color light emission period RON.

Then, in a second sub-frame (second predetermined time) GF, the light emitting body 33G of the second color emits light during a second color light emission period GON, and the pixels Pix selected during the one vertical scanning period GateScan scatter light to perform display. On the entire display panel 2, for the pixels Pix selected during the one vertical scanning period GateScan, if the gradation signal corresponding to the output gradation value of each of the pixels Pix is supplied to the above-described signal lines SL, only the second color is lit up during the second color light emission period GON.

Furthermore, in a third sub-frame (third predetermined time) BF, the light emitting body 33B of the third color emits light during a third color light emission period BON, and the pixels Pix selected during the one vertical scanning period GateScan scatter light to perform display. On the entire display panel 2, for the pixels Pix selected during the one vertical scanning period GateScan, if the gradation signal corresponding to the output gradation value of each of the pixels Pix is supplied to the above-described signal lines SL, only the third color is lit up during the third color light emission period BON.

Since a human eye has limited temporal resolving power, and produces an afterimage, an image with a combination of three colors is recognized in a period of one frame (1F). The field-sequential system can eliminate the need for a color filter, and thus can reduce an absorption loss by the color filter. As a result, higher transmittance can be obtained. In the color filter system, one pixel is made up of sub-pixels obtained by dividing each of the pixels Pix into the sub-pixels of the first color, the second color, and the third color. In contrast, in the field-sequential system, the pixel need not be divided into the sub-pixels in such a manner. A fourth sub-frame may be further included to emit light in a fourth color different from any one of the first color, the second color, and the third color.

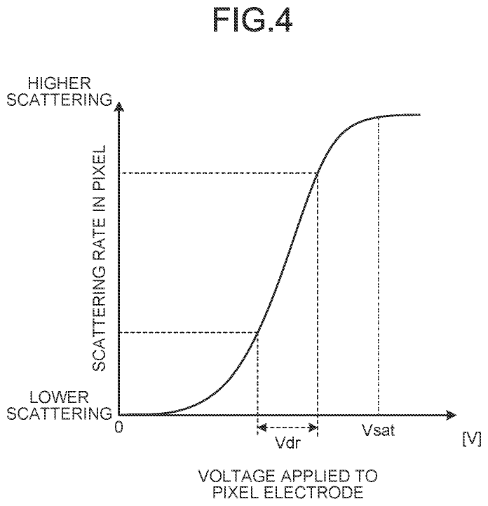

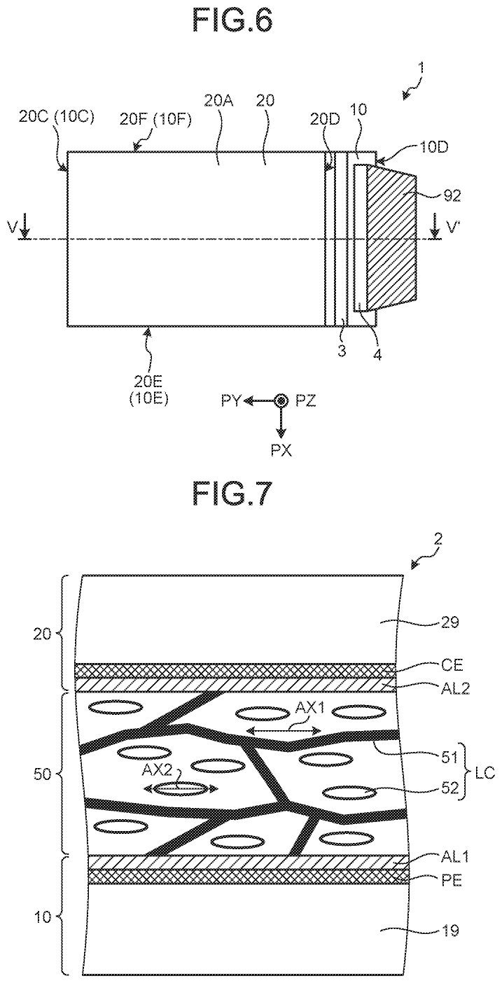

FIG. 4 is an explanatory diagram illustrating a relation between a voltage applied to the pixel electrode and a scattering state of the pixel. FIG. 5 is a sectional view illustrating an example of a section of the display device of FIG. 1. FIG. 6 is a plan view illustrating a planar surface of the display device of FIG. 1. FIG. 5 is a V-V′ sectional view of FIG. 6.

For the pixels Pix selected during the one vertical scanning period GateScan, if the gradation signal corresponding to the output gradation value of each of the pixels Pix is supplied to the above-described signal lines SL, a voltage applied to the pixel electrode PE changes with the gradation signal. The change in the voltage applied to the pixel electrode PE changes the voltage between the pixel electrode PE and the common electrode CE. The scattering state of the liquid crystal layer 50 for each of the pixels Pix is controlled in accordance with the voltage applied to the pixel electrode PE, and the scattering rate in the pixels Pix changes, as illustrated in FIG. 4.

As illustrated in FIG. 4, the change in the scattering rate in the pixel Pix is smaller when the voltage applied to the pixel electrode PE is equal to or higher than a saturation voltage Vsat. Therefore, the drive circuit 4 changes the voltage applied to the pixel electrode PE in accordance with the vertical drive signal VDS in a voltage range Vdr lower than the saturation voltage Vsat.

As illustrated in FIGS. 5 and 6, the array substrate 10 has a first principal surface 10A, a second principal surface 10B, a first side surface 10C, a second side surface 10D, a third side surface 10E, and a fourth side surface 10F. The first principal surface 10A and the second principal surface 10B are parallel surfaces. The first side surface 10C and the second side surface 10D are parallel surfaces. The third side surface 10E and the fourth side surface 10F are parallel surfaces.

As illustrated in FIGS. 5 and 6, the counter substrate 20 has a first principal surface 20A, a second principal surface 20B, a first side surface 20C, a second side surface 20D, a third side surface 20E, and a fourth side surface 20F. The first principal surface 20A and the second principal surface 20B are parallel surfaces. The first side surface 20C and the second side surface 20D are parallel surfaces. The third side surface 20E and the fourth side surface 20F are parallel surfaces.

As illustrated in FIGS. 5 and 6, the light source 3 is opposed to the second side surface 20D of the counter substrate 20. The light source 3 is sometimes called a side light source. As illustrated in FIG. 5, the light source 3 emits light-source light L to the second side surface 20D of the counter substrate 20. The second side surface 20D of the counter substrate 20 opposed to the light source 3 serves as a plane of light incidence.

As illustrated in FIG. 5, the light-source light L emitted from the light source 3 propagates in a direction (PY direction) away from the second side surface 20D while being reflected by the first principal surface 10A of the array substrate 10 and the first principal surface 20A of the counter substrate 20. When the light-source light L travels outward from the first principal surface 10A of the array substrate 10 or the first principal surface 20A of the counter substrate 20, the light-source light L enters a medium having a lower refractive index from a medium having a higher refractive index. Hence, if the angle of incidence of the light-source light L incident on the first principal surface 10A of the array substrate 10 or the first principal surface 20A of the counter substrate 20 is larger than a critical angle, the light-source light L is fully reflected by the first principal surface 10A of the array substrate 10 or the first principal surface 20A of the counter substrate 20.

As illustrated in FIG. 5, the light-source light L that has propagated in the array substrate 10 and the counter substrate 20 is scattered by the pixels Pix including liquid crystal molecules placed in the scattering state, and the angle of incidence of the scattered light becomes an angle smaller than the critical angle. Thus, emission light 68 or 68A is emitted outward from the first principal surface 20A of the counter substrate 20 or the first principal surface 10A of the array substrate 10, respectively. The emission light 68 or 68A emitted outward from the first principal surface 20A of the counter substrate 20 or the first principal surface 10A of the array substrate 10 is viewed by a viewer.

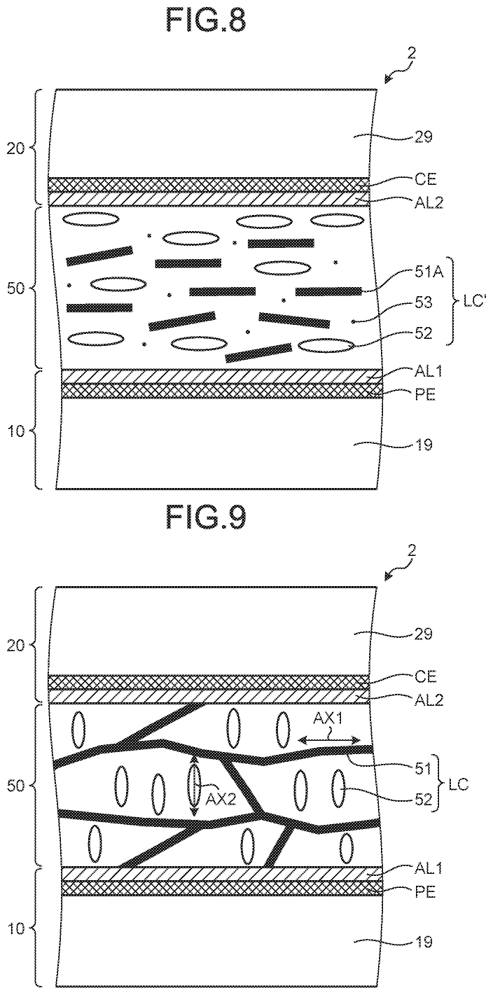

The following describes the array substrate 10, the counter substrate 20, and the liquid crystal layer 50 that form the display panel 2. FIG. 7 is an enlarged sectional view obtained by enlarging the liquid crystal layer portion of FIG. 5. FIG. 7 illustrates the liquid crystal layer after the monomer has been polymerized. FIG. 7 illustrates the liquid crystal layer in a non-scattering state. FIG. 8 is a sectional view illustrating a state of the monomer before being polymerized in the liquid crystal layer. FIG. 9 is a sectional view for explaining the scattering state in the liquid crystal layer.

As illustrated in FIG. 7, the array substrate 10 includes a first light-transmitting base member 19, the pixel electrode PE, and a first alignment film (alignment film) AL1. The counter substrate 20 includes a second light-transmitting base member 29, the common electrode CE, and a second alignment film AL2. The liquid crystal layer 50 is sealed between the first alignment film AL1 and the second alignment film AL2.

The first and the second light-transmitting base members 19 and 29 are formed of a light-transmitting material such as glass or polyethylene terephthalate. The pixel electrode PE and the common electrode CE are formed of a light-transmitting conductive material such as indium tin oxide (ITO). The first and the second alignment films AL1 and AL2 align liquid crystal molecules 52 (to be described later) in the liquid crystal layer 50 in a predetermined direction, and are formed of a light-transmitting alignment film material such as a polyimide. In the present embodiment, for example, rubbing treatment (rubbing alignment treatment) is applied to surfaces (surfaces to be in contact with the liquid crystal layer 50) of the first and the second alignment films AL1 and AL2, and whereby the first and the second alignment films AL1 and AL2 are made to be horizontal alignment films. The rubbing treatment refers to rubbing the surfaces of the first and the second alignment films AL1 and AL2 with, for example, a cloth along one direction to make the surfaces anisotropic so as to give the films a liquid crystal orientation. A specific configuration of the first and the second alignment films AL1 and AL2 will be described later.

As illustrated in FIG. 8, a solution LC′ containing a plurality of photocrosslinkable monomers 51A, the liquid crystal molecules 52, and photopolymerization initiators 53 is injected between the first alignment film AL1 and the second alignment film AL2. The monomers 51A and the liquid crystal molecules 52 are uniformly homogeneously aligned in a substantially horizontal direction between the first alignment film AL1 and the second alignment film AL2 (array substrate 10 and counter substrate 20) by the rubbing treatment of the first and the second alignment films AL1 and AL2. When light is emitted for a one drop fill (ODF) process after the solution LC′ is injected, mask exposure is preferably performed in order not to allow the light to be incident on portions other than a sealing portion (not illustrated) for sealing the array substrate 10 and the counter substrate 20.

Then, in the state where the monomers 51A and the liquid crystal molecules 52 are homogeneously aligned, a bright line of a mercury lamp or a light-emitting diode (LED) light source is used to emit light having an absorption wavelength of the photopolymerization initiators 53 (for example, ultraviolet light such as i-line, g-line, or h-line). In this case, since the array substrate 10 has relatively large irregularities such as asperities, the ultraviolet light is preferably emitted from the flat counter substrate 20 side rather than from the array substrate 10 side on which the irregularities need to be dealt with. As a result, a photocrosslinking reaction can be performed without problem in a black matrix (BM) and wiring on the array substrate 10 that have low light transmittance.

In the present embodiment, a photocrosslinkable acrylate-based material represented by Chemical Formula 1 can be used as the monomers 51A. Each of the monomers represented by Chemical Formula 1 has acrylate groups having functions as photocrosslinkable groups at the right and left ends.

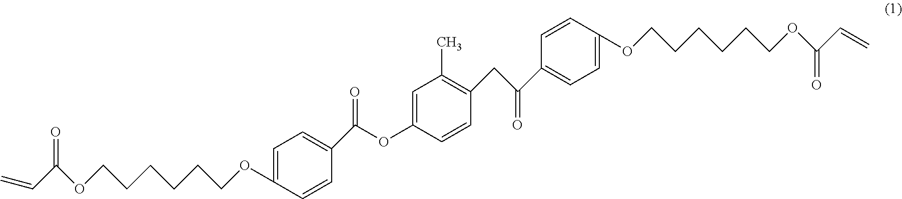 [SMILES: C=CC(=O)OCCCCCCOc1ccc(C(=O)Cc2ccc(OC(=O)c3ccc(OCCCCCCOC(=O)C=C)cc3)cc2C)cc1]

The ultraviolet irradiation described above causes the photopolymerization initiators 53 in the solution LC′ to absorb light and generate radicals. As a result, the monomers 51A in the solution LC′ perform a cross-linking reaction and are polymerized. The monomer 51A is not limited to that represented by Chemical Formula 1 above, and can be made using a photocrosslinkable material such as acrylate groups represented by Chemical Formulae 2-1 to 2-4 or maleimide groups represented by Chemical Formulae 2-5 to 2-8.

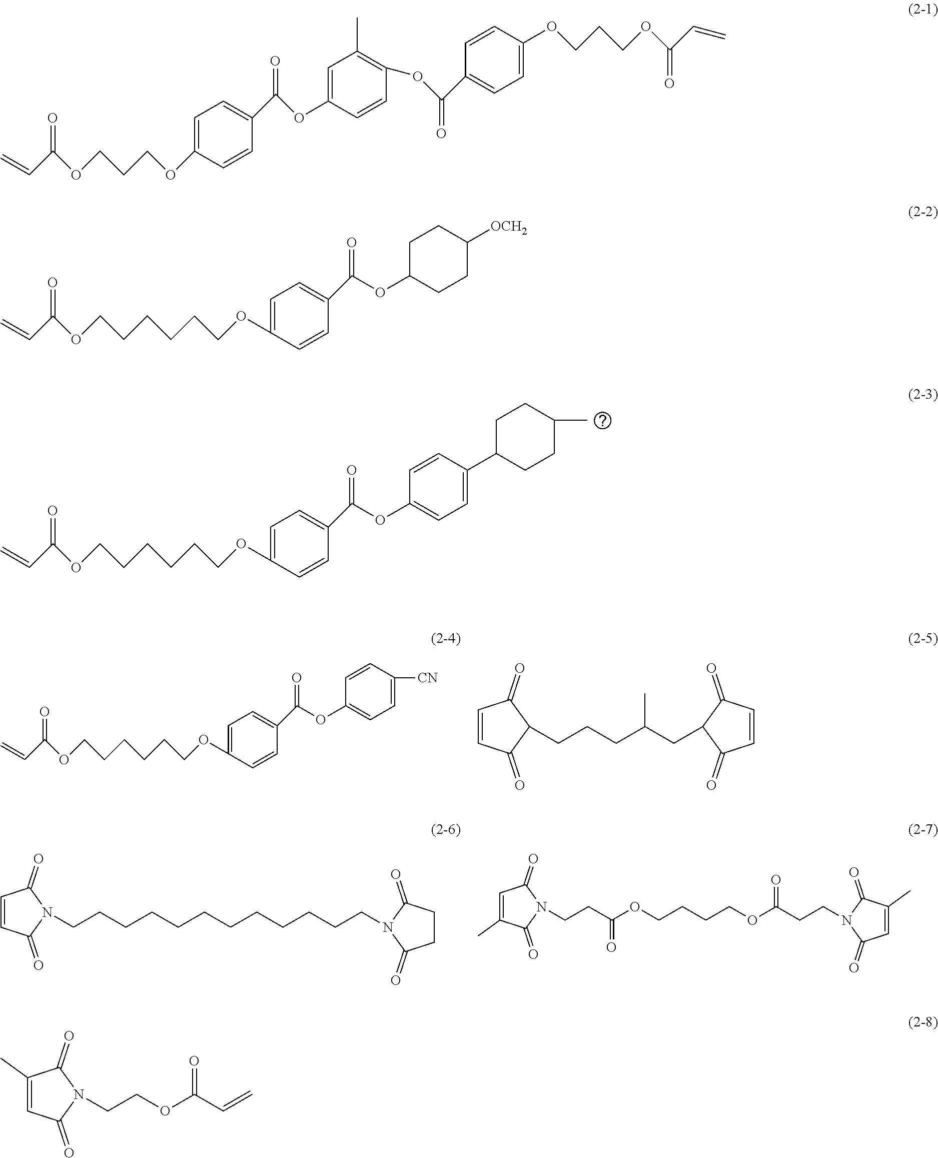

The liquid crystal molecules 52 are made using a nematic liquid crystal material having positive dielectric constant anisotropy Δε. When a liquid crystal material having positive dielectric constant anisotropy Δε is used, a liquid crystal composition (liquid crystal molecules 52) having large refractive index anisotropy Δn is preferably used, and the photocrosslinkable monomers 51A and the photopolymerization initiators 53 are included in addition to the liquid crystal molecules 52.

The ultraviolet irradiation at a predetermined wavelength causes the photopolymerization initiators 53 to generate radicals to initiate the polymerization of the monomers 51A. As the photopolymerization initiators 53, a material suitable for the ultraviolet wavelength to be used can be used. For example, one of the following can be used.

(±)-camphorquinone, acetophenone, benzophenone, 4-benzoylbenzoic acid, 2-benzoylbenzoic acid, methyl 2-benzoylbenzoate, 4,4′-bis(dimethylamino)benzophenone, 4,4′-bis(diethylamino)benzophenone, 4,4′-dichlorobenzophenone, 1,4-dibenzophenone, benzil, p-anisil, 2-benzoyl-2-propanol, 2-hydroxy-4′-(2-hydroxyethoxy)-2-methylpropiophenone, 1-benzylcyclohexanol, benzoin, benzoin methyl ether, benzoin ethyl ether, benzoin isopropyl ether, benzoin butyl ether, o-tosyl benzoin, 2,2-diethoxyacetophenone, benzil dimethyl ketal, 2-methyl-4′-(methylthio)-2-morpholinopropiophenone, 2-benzyl-2-(dimethylamino)-4′-monoholinobutyrophenone, 2-isonitrosopropiophenone, 2-chlorothioxanthone, 2-isopropylthioxanthone, 2,4-diethylthioxanthen-9-one, 2,2′-bis(2-chlorophenyl)-4,4,5,5′-tetraphenyl-1,2′-biimidazole, diphenyl(2,4,6-trimethylbenzoyl)phosphine oxide, phenylbis(2,4,6-trimethylbenzoyl)phosphine oxide, and lithium phenyl (2,4,6-trimethylbenzoyl) phosphinate.

The photocrosslinking (polymerizing) reaction of the monomers 51A described above forms a three-dimensional mesh-shaped polymer network 51, as illustrated in FIG. 7. This process forms the liquid crystal layer 50 including the reverse-mode polymer dispersed liquid crystal LC in which the liquid crystal molecules 52 are dispersed in gaps of the polymer network 51.

Normally, when the polymer network is formed by polymerizing the monomers, the polymer network is not fixed and floats in the liquid crystal layer. Therefore, for example, repetition of point presses or drop impact on a screen of the display panel irreversibly moves the polymer network of the liquid crystal layer, thereby disturbing the orientation of the liquid crystal molecules. This phenomenon causes unevenness and reduced contrast in the vicinity of the center of the screen of the display panel, and thus, improvement is required in impact resistance of the display device (display panel).

In the present embodiment, ends (portions) of the polymer network 51 is connected to the first and the second alignment films AL1 and AL2. As a result, the polymer network 51 is fixed to the array substrate 10 and the counter substrate 20 with the first and the second alignment films AL1 and AL2 interposed therebetween. This configuration improves the impact resistance and reliability of the display panel 2 including the liquid crystal layer 50. The configuration may be such that an end (portion) of the polymer network 51 is connected to either one of the first and the second alignment films AL1 and AL2.

The following describes a configuration of the first and the second alignment films AL1 and AL2. In the present embodiment, as the first and the second alignment films AL1 and AL2, alignment films that are transparent in the visible range are preferably formed of the polyimide. The polyimide can be obtained by heating and imidizing a polyamide acid (including a polyamide acid compound). For this purpose, a liquid polyamide acid is applied to surfaces of the pixel electrode PE and the common electrode CE by, for example, spin coating, and is imidized to form the first and the second alignment films AL1 and AL2. The polyamide acid can be synthesized by reacting a tetracarboxylic acid compound (tetracarboxylic dianhydride) with a diamine compound. As a result, as represented by Chemical Formula 3, the polyimide is formed having a skeleton derived from tetracarboxylic dianhydride and a skeleton derived from a diamine compound.

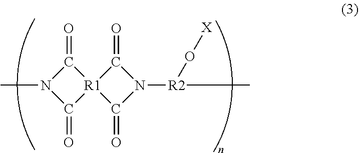

In Chemical Formula 3, R1 contained in the skeleton derived from tetracarboxylic dianhydride can be, for example, a cyclobutane skeleton, an alicyclic skeleton other than a cyclobutane skeleton, or a chain skeleton. R2 contained in the skeleton derived from a diamine compound can be, for example, an alicyclic skeleton other than a cyclobutane skeleton, or a chain skeleton. Examples of an alicyclic skeleton other than a cyclobutane skeleton include a cycloheptane skeleton and a cyclohexane skeleton. As an alicyclic skeleton, aromatic compounds can be used. However, those with less coloration of the polyimide are preferred.

In the present embodiment, the polyimide serving as the material (alignment film material) of the first and the second alignment films AL1 and AL2 has a photocrosslinkable group X on a side chain of the polyimide. Specifically, the photocrosslinkable group X is provided via an ether bond to the above-mentioned R2 that forms the skeleton derived from the diamine compound. The photocrosslinking group X may be provided via an ester bond instead of an ether bond. That is, the diamine compound forming the polyimide has the photocrosslinkable group X. The photocrosslinkable group X reacts with the monomers 51A during the above-described photocrosslinking (polymerizing) reaction of the monomers 51A, and connects the respective first and the second alignment films AL1 and AL2 to the polymer network 51 (polymer fibers). This process tightly connects the first and the second alignment films AL1 and AL2 to the polymer network 51, thereby improving the impact resistance and reliability of the display panel 2 including the liquid crystal layer 50.

The photocrosslinkable group X can be provided with, for example, an acrylate group as represented by Chemical Formula 4. In this case, R illustrated in Chemical Formula 4 means a group connected to the photocrosslinkable group and includes the ether bond or the ester bond mentioned above.

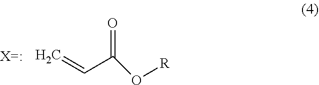

In this configuration, the photocrosslinkable group X is provided via the ether bond or the ester bond to the R2 contained in the skeleton derived from the diamine compound. As a result, the first and the second alignment films AL1 and AL2 including the polyimide containing the photocrosslinkable group X can be easily formed, and the first and the second alignment films AL1 and AL2 can be easily connected to the polymer network 51. Since the photocrosslinkable group X is provided on the side chain of the polyimide, the degree of freedom of orientation is higher than when the photocrosslinkable group X is provided on a polymer main chain, and the efficiency of the photocrosslinking (polymerizing) reaction between the photocrosslinkable group X and the photocrosslinkable monomers 51A can be increased during the formation of the polymer network 51.

The photocrosslinkable group X is not limited to the acrylate group. At least one of a methacrylate group, a cinnamic acid group, a maleimide group, a phenyldiazirine, and a phenylazide represented by Chemical Formulae 5-1 to 5-5 may be provided on the side chain of the polyimide. Any one of these photocrosslinkable groups X may be provided on the main chain of the polyimide, or on the side chain or at an end of the main chain.

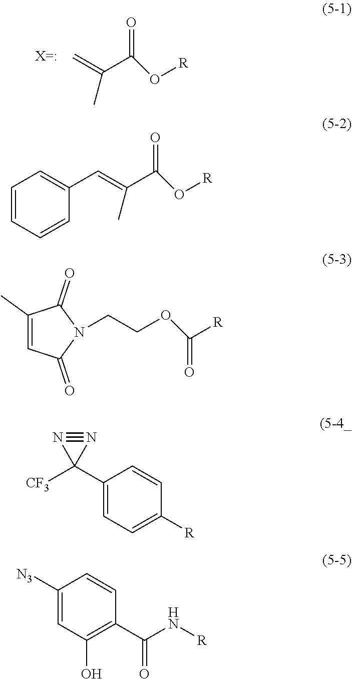

The following describes the polyimide having other configurations. Although the above has described the configuration of the polyimide having the photocrosslinkable group X on the side chain, a configuration can also be employed in which the polyimide has the photocrosslinkable group on the main chain. Specifically, the polyimide having a diazo group represented by Chemical Formula 6-1 or the polyimide having a benzophenone group represented by Chemical Formula 6-2 can be employed as the photocrosslinkable group for the R1 contained in the skeleton derived from tetracarboxylic dianhydride in Chemical Formula 3. In Chemical Formulae 6-1 and 6-2, Et denotes an ethyl group. Structural formulae illustrated in Chemical Formulae 6-1 and 6-2 are examples, and other configurations may be used as long as the polyimide has a diazo group or a benzophenone group.

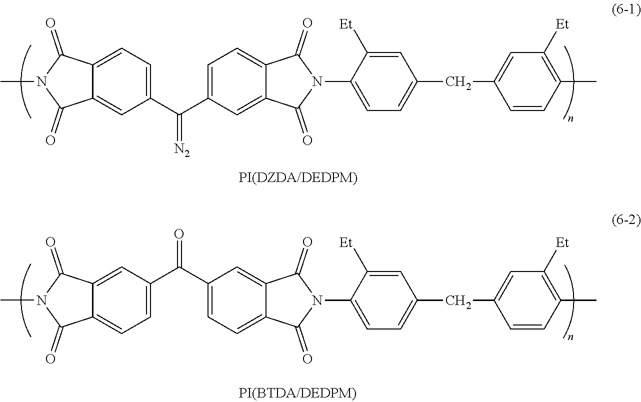

In this configuration, since the polyimide originally has a functional group that serves as a photocrosslinkable group, the connection of the first and the second alignment films AL1 and AL2 to the polymer network 51 can be easily performed. The photocrosslinkable group is provided on the main chain of the polyimide. Therefore, after the first and the second alignment films AL1 and AL2 are connected to the polymer network 51, the polymer network 51 is difficult to move and thus can be fixed.

In the above-described configuration, both the polymer network 51 and the liquid crystal molecules 52 are optically anisotropic. The orientation of the liquid crystal molecules 52 is controlled by a voltage difference between the pixel electrode PE and the common electrode CE. The orientation of the liquid crystal molecules 52 is changed by the voltage applied to the pixel electrode PE. The degree of scattering of light passing through the pixel Pix (area on the pixel electrode PE) changes with the change in the orientation of the liquid crystal molecules 52.

For example, as illustrated in FIG. 7, the direction of an optical axis AX1 of the polymer network 51 is substantially equal to the direction of an optical axis AX2 of the liquid crystal molecules 52 when no voltage is applied between the pixel electrode PE and the common electrode CE. The optical axis AX2 of the liquid crystal molecules 52 is parallel to the PY direction of the liquid crystal layer 50 (FIG. 5). The optical axis AX1 of the polymer network 51 is parallel to the PY direction of the liquid crystal layer 50 regardless of whether the voltage is applied.

Ordinary-ray refractive indices of the polymer network 51 and the liquid crystal molecules 52 are equal to each other. When no voltage is applied between the pixel electrode PE and the common electrode CE, the difference of refractive index between the polymer network 51 and the liquid crystal molecules 52 is substantially zero in all directions. The liquid crystal layer 50 is placed in the non-scattering state of not scattering the light-source light L (FIG. 5). As illustrated in FIG. 5, the light-source light L propagates in a direction away from the light source 3 (light emitter 31) while being reflected by the first principal surface 10A of the array substrate 10 and the first principal surface 20A of the counter substrate 20. When the liquid crystal layer 50 is in the non-scattering state of not scattering the light-source light L, a background on the first principal surface 20A side of the counter substrate 20 is visible from the first principal surface 10A of the array substrate 10, and a background on the first principal surface 10A side of the array substrate 10 is visible from the first principal surface 20A of the counter substrate 20.

As illustrated in FIG. 9, in the space between the pixel electrode PE and the common electrode CE having a voltage applied thereto, the optical axis AX2 of the liquid crystal molecules 52 is inclined by an electric field generated between the pixel electrode PE and the common electrode CE. Since the optical axis AX1 of the polymer network 51 is not changed by the electric field, the direction of the optical axis AX1 of the polymer network 51 differs from the direction of the optical axis AX2 of the liquid crystal molecules 52. The light-source light L is scattered in the pixel Pix including the pixel electrode PE having a voltage applied thereto. The viewer views a part of the light-source light L that is scattered as described above and emitted outward from the first principal surface 10A of the array substrate 10 or the first principal surface 20A of the counter substrate 20.

In the pixel Pix including the pixel electrode PE having no voltage applied thereto, the background on the first principal surface 20A side of the counter substrate 20 is visible from the first principal surface 10A of the array substrate 10, and the background on the first principal surface 10A side of the array substrate 10 is visible from the first principal surface 20A of the counter substrate 20. In the display device 1 of the present embodiment, when the first input signal VS is received from the image transmitter 91, a voltage is applied to the pixel electrode PE of the pixel Pix for displaying an image, and an image based on the third input signal VCSA becomes visible together with the background. In this manner, the image is displayed in the display area when the polymer-dispersed liquid crystal LC is in a scattering state.

The light-source light L is scattered in the pixel Pix including the pixel electrode PE having a voltage applied thereto, and emitted outward to display the image, which is displayed so as to be superimposed on the background. In other words, the display device 1 of the present embodiment can display the image so as to be superimposed on the background by combining the emission light 68 or the emission light 68A with the background.

In order to verify the effect of the present embodiment, the following display panels were produced: one was provided with the first and the second alignment films AL1 and AL2 formed of the polyimide having the photocrosslinkable group X described above, and the other was provided with the first and the second alignment films AL1 and AL2 formed of the polyimide having no photocrosslinkable group. The configurations were the same except for whether the photocrosslinkable group is provided.

Impact resistance tests were conducted for the produced display panels. In each of the impact resistance tests, a rod-shaped support was inserted under one side of the display panel to place the display panel in a floating state, and a point at substantially the center of the display panel was repeatedly pressed from the upper side at a predetermined force (for example, 10 kPa) a predetermined number of times (for example, five to ten times). The results of the tests were as follows: The display panel provided with the first and the second alignment films AL1 and AL2 not having the photocrosslinkable group X generated an unevenness defect (for example, uneven white), which reduces the contrast of the display panel, at and near the center of the screen. In contrast, the display panel provided with the first and the second alignment films AL1 and AL2 having the photocrosslinkable group X exhibited almost no such reduction in contrast, and the impact resistance of the display panel (transparent display) was improved.

### Second Embodiment

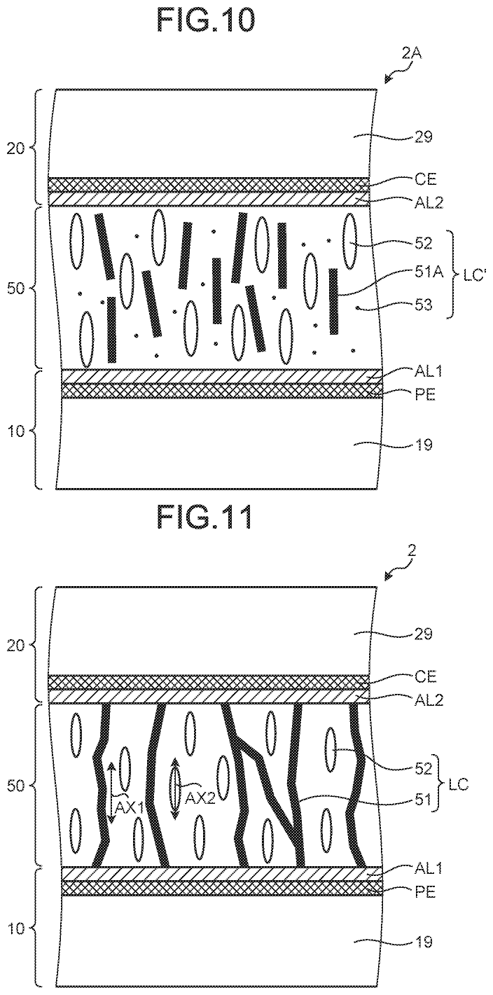

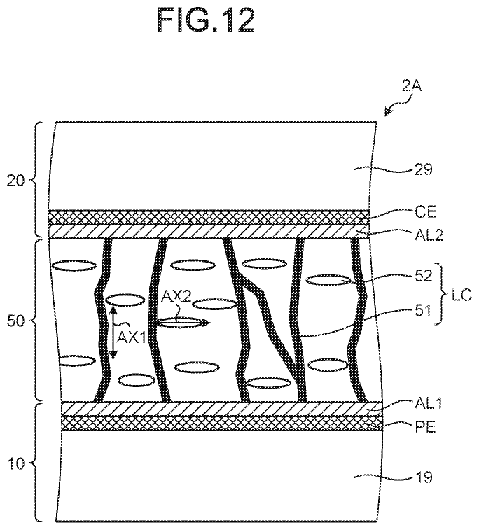

FIG. 10 is a sectional view illustrating a state of the monomer before being polymerized in the liquid crystal layer according to a second embodiment of the present disclosure. FIG. 11 is a sectional view for explaining a non-scattering state in the liquid crystal layer. FIG. 12 is a sectional view for explaining the scattering state in the liquid crystal layer. FIGS. 11 and 12 illustrate the liquid crystal layer after the monomer has been polymerized. The same components as those described in the above-described embodiment are denoted by the same reference numerals, and the description thereof will not be repeated.

In the present embodiment, for example, the rubbing treatment (rubbing alignment treatment) is applied to the surfaces (surfaces to be in contact with the liquid crystal layer 50) of the first and the second alignment films AL1 and AL2, and thereby, the first and the second alignment films AL1 and AL2 are made to be vertical alignment films. As illustrated in FIG. 10, the solution LC′ containing the photocrosslinkable monomers 51A, the liquid crystal molecules 52, and the photopolymerization initiators 53 is injected between the first alignment film AL1 and the second alignment film AL2. The liquid crystal molecules 52 are made using a nematic liquid crystal material having negative dielectric constant anisotropy Δε. The same materials as those in the first embodiment can be used for the monomers 51A and the photopolymerization initiators 53. The monomers 51A and the liquid crystal molecules 52 are uniformly homeotropically aligned in a substantially vertical direction between the first alignment film AL1 and the second alignment film AL2 (array substrate 10 and counter substrate 20) by the rubbing treatment of the first and the second alignment films AL1 and AL2. In order to define the tilt direction of the liquid crystal molecules 52 in a plane when the electric field is applied, a pretilt angle of 85 degrees to 88 degrees is given by the rubbing treatment. The rubbing direction at the time of the rubbing treatment is preferably orthogonal to the propagation direction of the light-source light L because a high scattering intensity can be obtained. When ultraviolet light having a predetermined wavelength is emitted in this state in the same manner as in the first embodiment described above, the photocrosslinking (polymerizing) reaction of the monomers 51A described above forms the three-dimensional mesh-shaped polymer network 51 as illustrated in FIG. 11. This process forms the liquid crystal layer 50 including the reverse-mode polymer dispersed liquid crystal LC in which the liquid crystal molecules 52 are dispersed in gaps of the polymer network 51.

The same alignment film material (polyimide) as that in the first embodiment described above can also be used as the first and the second alignment films AL1 and AL2. In addition, in the present embodiment, considering that the first and the second alignment films AL1 and AL2 are vertical alignment films, the polyimide represented by Chemical Formula 7 is preferably used. The polyimide represented by Chemical Formula 7 is provided, at an end of a side chain, with an acrylate group serving as the photocrosslinkable group X. This acrylate group is connected to an ether group via R3 serving as a chain skeleton. This R3 is a long-chain alkyl group ((CH₂)ₙ; n=1 to 12), in particular, n=6 to 12. In addition, the pretilt angle of the liquid crystal molecules 52 more easily increases as the density of the long-chain alkyl group increases, which is effective when forming the vertical alignment films.

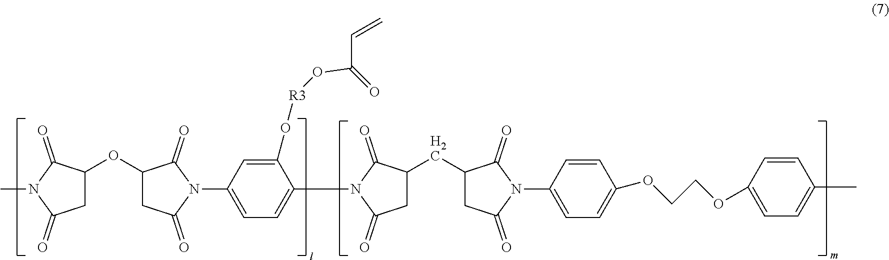

Also, in the present embodiment, the orientation of the liquid crystal molecules 52 is controlled by the voltage difference between the pixel electrode PE and the common electrode CE. For example, as illustrated in FIG. 11, the direction of the optical axis AX1 of the polymer network 51 is substantially equal to the direction of the optical axis AX2 of the liquid crystal molecules 52 when no voltage is applied between the pixel electrode PE and the common electrode CE. The optical axis AX2 of the liquid crystal molecules 52 is parallel to the PZ direction of the liquid crystal layer 50 (FIG. 5). The optical axis AX1 of the polymer network 51 is parallel to the PZ direction of the liquid crystal layer 50 regardless of whether the voltage is applied.

When no voltage is applied between the pixel electrode PE and the common electrode CE, the difference of refractive index between the polymer network 51 and the liquid crystal molecules 52 is zero in all directions. As a result, the liquid crystal layer 50 is placed in the non-scattering state of not scattering the light-source light L (FIG. 5). When the liquid crystal layer 50 is in the non-scattering state of not scattering the light-source light L, the background on the first principal surface 20A side of the counter substrate 20 is visible from the first principal surface 10A of the array substrate 10, and the background on the first principal surface 10A side of the array substrate 10 is visible from the first principal surface 20A of the counter substrate 20.

As illustrated in FIG. 12, in the space between the pixel electrode PE and the common electrode CE having a voltage applied thereto, the optical axis AX2 of the liquid crystal molecules 52 is inclined by the electric field generated between the pixel electrode PE and the common electrode CE. Since the optical axis AX1 of the polymer network 51 is not changed by the electric field, the direction of the optical axis AX1 of the polymer network 51 differs from the direction of the optical axis AX2 of the liquid crystal molecules 52. The light-source light L is scattered in the pixel Pix including the pixel electrode PE having a voltage applied thereto. The viewer views a part of the light-source light L that is scattered as described above and emitted outward from the first principal surface 10A of the array substrate 10 or the first principal surface 20A of the counter substrate 20.

In the pixel Pix including the pixel electrode PE having no voltage applied thereto, the background on the first principal surface 20A side of the counter substrate 20 is visible from the first principal surface 10A of the array substrate 10, and the background on the first principal surface 10A side of the array substrate 10 is visible from the first principal surface 20A of the counter substrate 20. In the display device 1 of the present embodiment, when the first input signal VS is received from the image transmitter 91, a voltage is applied to the pixel electrode PE of the pixel Pix for displaying an image, and the image based on the third input signal VCSA becomes visible together with the background. In this manner, the image is displayed in the display area when the polymer-dispersed liquid crystal LC is in the scattering state.

The light-source light L is scattered in the pixel Pix including the pixel electrode PE having a voltage applied thereto, and is emitted outward to display the image, which is displayed so as to be superimposed on the background. In other words, the display device 1 of the present embodiment can display the image so as to be superimposed on the background by combining the emission light 68 or the emission light 68A with the background.

Also, in the present embodiment, the results of the above-described impact tests were as follows: The display panel provided with the first and the second alignment films AL1 and AL2 not having the photocrosslinkable group X generated the unevenness defect, which reduces the contrast of the display panel, at and near the center of the screen. In contrast, the display panel provided with the first and the second alignment films AL1 and AL2 having the photocrosslinkable group X exhibited almost no such reduction in contrast, and the impact resistance of the display panel (transparent display) was improved.

### Third Embodiment

In a third embodiment of the present disclosure, the configuration is mainly the same as that of the first embodiment described above. Therefore, the same components as those described in any of the above-described embodiments are denoted by the same reference numerals, and the description thereof will not be repeated. Also, in the third embodiment, the same materials as those in the above-described embodiments can be used as the monomers 51A constituting the polymer network 51, the liquid crystal molecules 52, the photopolymerization initiators 53, and the first and the second alignment films AL1 and AL2.

Also, in the present embodiment, the first and the second alignment films AL1 and AL2 are horizontal alignment films, and the liquid crystal molecules 52 are positive nematic liquid crystal molecules. A difference from the first embodiment is that the surfaces of the first and the second alignment films AL1 and AL2 are subjected to photo-alignment treatment instead of the rubbing treatment. The photo-alignment treatment refers to a treatment in which surfaces of the first and the second alignment films AL1 and AL2 are irradiated with linearly polarized ultraviolet light to selectively react polymer chains in the direction of the polarization, and to thereby generate anisotropy to give the films a liquid crystal orientation.

In this case, the linearly polarized ultraviolet light to be used for the photo-alignment treatment preferably has a wavelength different from that of the ultraviolet light to be used for the photopolymerization reaction caused by the photopolymerization initiators 53 contained in the solution LC′. In contrast, light (ultraviolet light) having substantially the same wavelength may be used when the photoalignment films are made based on, for example, a photodegradation reaction or a photoisomerization reaction, which is a photoreaction different from that mainly uses the radical reaction for providing the above-described photocrosslinkable group. Examples of the material of the photoalignment films based on the photodegradation include the polyimide (alignment film material) containing repeated skeletons illustrated in Chemical Formula 8. When a surface of the polyimide is irradiated with the linearly polarized ultraviolet light, molecules oriented along the direction of the polarization of the linearly polarized ultraviolet light are preferentially decomposed. As a result of an interaction of the liquid crystal molecules 52 with the remaining undecomposed polyimide molecules at an interface therebetween, the liquid crystal molecules 52 and the monomers 51A are uniformly homogeneously aligned in a substantially horizontal direction between the first alignment film AL1 and the second alignment film AL2 (array substrate 10 and counter substrate 20).

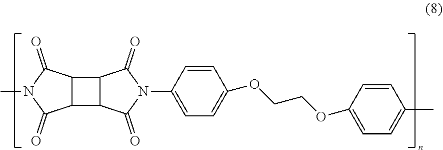

Examples of the material of the photoalignment films based on the photoisomerization include the polyimide (alignment film material) containing a skeleton capable of light-induced cis-trans isomerization, such as an azobenzene skeleton, illustrated in Chemical Formula 9, as a part of the diamine compound serving as a component of the polyimide. The material of the photoalignment films may be a polyimide that contains a stilbene skeleton as a part of the diamine compound.

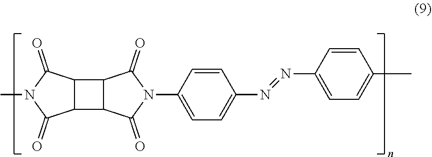

Also, in the present embodiment, the results of the above-described impact tests were as follows: The display panel provided with the first and the second alignment films AL1 and AL2 not having the photocrosslinkable group X generated the unevenness defect, which reduces the contrast of the display panel, at and near the center of the screen. In contrast, the display panel provided with the first and the second alignment films AL1 and AL2 having the photocrosslinkable group X exhibited almost no such reduction in contrast, and the impact resistance of the display panel (transparent display) was improved.

While the preferred embodiments have been described above, the present disclosure is not limited to such embodiments. The content disclosed in the embodiments is merely an example, and can be variously modified within the scope not departing from the gist of the present disclosure. Any modifications appropriately made within the scope not departing from the gist of the present disclosure also naturally belong to the technical scope of the present disclosure.

For example, in the embodiments described above, the configuration has been described that employs the polyimide composed of the imidized polyamide acid as the alignment film material of the first and the second alignment films AL1 and AL2. However, the alignment film material is not limited thereto and may be polyamideimide illustrated in Chemical Formula 10.

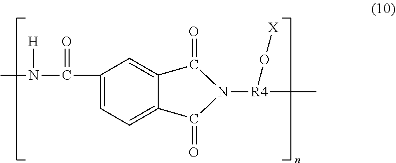

In Chemical Formula 10, R4 represents, for example, an aromatic compound. The photocrosslinkable group X is provided to this aromatic compound via an ether group. Therefore, even when the first and the second alignment films AL1 and AL2 are formed using the polyamideimide, the polymer network 51 is tightly connected to the first and the second alignment films AL1 and AL2 during the photopolymerization reaction. As a result, the impact resistance and reliability of the display panel 2 including the liquid crystal layer 50 are improved.

A soluble polyimide can also be employed as the alignment film material of the first and the second alignment films AL1 and AL2. Since the soluble polyimide can be used by being dissolved in a solvent, the first and the second aligned films AL1 and AL2 can be easily generated. Also, in this soluble polyimide, the photocrosslinkable group X is provided to the R2 contained in the skeleton derived from the diamine compound given by Chemical Formula 3 above via the ether bond or the ester bond. Therefore, the first and the second alignment films AL1 and AL2 including the polyimide containing the photocrosslinkable group X can be easily formed, and the first and the second alignment films AL1 and AL2 can be easily connected to the polymer network 51.

In the embodiments described above, the case has been described where a vertical electric field is applied in the direction of thickness of the display panel 2. However, the present disclosure is not limited to this case. A configuration may be employed in which a comb electrode formed in a comb shape is provided on one of the substrates (for example, the array substrate 10), and a horizontal electric field is applied. This configuration also provides the same operational effect as that in the case of applying the vertical electric field.

While the preferred embodiments have been described above, the present disclosure is not limited to such embodiments. The content disclosed in the embodiments is merely an example, and can be variously modified within the scope not departing from the gist of the present disclosure. Any modifications appropriately made within the scope not departing from the gist of the present disclosure also naturally belong to the technical scope of the present disclosure.

What is claimed is:

1. A liquid crystal display device comprising:
a first light-transmitting substrate;
a second light-transmitting substrate disposed so as to be opposed to the first light-transmitting substrate;
a liquid crystal layer sealed between the first light-transmitting substrate and the second light-transmitting substrate;
alignment films that are provided to the first light-transmitting substrate and the second light-transmitting substrate, respectively, and are in contact with the liquid crystal layer; and
at least one light emitter disposed so as to be opposed to at least one of side surfaces of the first light-transmitting substrate and the second light-transmitting substrate, wherein
the liquid crystal layer includes a polymer-dispersed liquid crystal comprising a polymer network formed in a mesh shape and liquid crystal molecules held in a dispersed manner in gaps of the polymer network, and
each of the alignment films comprises a photocrosslinkable group connected to the polymer network.

2. The liquid crystal display device according to claim 1, wherein each of the alignment films comprises at least one of a polyimide comprising a polyamide acid, a polyamideimide, or a soluble polyimide.

3. The liquid crystal display device according to claim 1, wherein rubbing alignment treatment is applied to a surface of each of the alignment films that contacts the liquid crystal layer.

4. The liquid crystal display device according to claim 1, wherein photo-alignment treatment is applied to a surface of each of the alignment films that contacts the liquid crystal layer.

5. The liquid crystal display device according to claim 1, wherein each of the alignment films includes a polyimide comprising, on a side chain, the photocrosslinkable group comprising at least one of a methacrylate group, an acrylate group, a cinnamic acid group, a maleimide group, a phenyldiazirine, or a phenylazide.

6. The liquid crystal display device according to claim 1, wherein each of the alignment films includes a polyimide comprising, on a main chain, a diazo group or a benzophenone group as the photocrosslinkable group.

7. The liquid crystal display device according to claim 1, wherein the liquid crystal molecules and the polymer network are homogeneously aligned or homeotropically aligned between the first light-transmitting substrate and the second light-transmitting substrate.

8. The liquid crystal display device according to claim 1, wherein
an image is displayed in a display area when the polymer-dispersed liquid crystal is in a scattering state, and
in the display area, a background of the second light-transmitting substrate is visible from the first light-transmitting substrate, and a background of the first light-transmitting substrate is visible from the second light-transmitting substrate when the polymer-dispersed liquid crystal is in a non-scattering state.
